(19) United States
(12) Patent Application Publication
(10) Pub. No.: US 2024/0387804 A1
(43) Pub. Date: Nov. 21, 2024

(54) NEGATIVE ELECTRODE ACTIVE MATERIAL, AND NEGATIVE ELECTRODE PLATE AND BATTERY INCLUDING NEGATIVE ELECTRODE ACTIVE MATERIAL

(71) Applicant: ZHUHAI COSMX BATTERY CO., LTD., Zhuhai (CN)

(72) Inventors: Chunyang LIU, Zhuhai (CN); Ruofan CHEN, Zhuhai (CN); Suli LI, Zhuhai (CN); Junyi LI, Zhuhai (CN); Yanming XU, Zhuhai (CN)

(73) Assignee: ZHUHAI COSMX BATTERY CO., LTD., Zhuhai (CN)

(21) Appl. No.: 18/788,638

(22) Filed: Jul. 30, 2024

Related U.S. Application Data
(63) Continuation-in-part of application No. PCT/CN2022/142629, filed on Dec. 28, 2022.

(30) Foreign Application Priority Data
Mar. 22, 2022 (CN) 202210288026.5

(51) Int. Cl. H01M 4/36; H01M 4/02; H01M 4/587

(52) U.S. Cl. CPC H01M 4/366; H01M 4/587; H01M 2004/021; H01M 2004/027

(57) ABSTRACT

Disclosed are a negative electrode active material, and a negative electrode plate and a battery including the negative electrode active material. The negative electrode active material of the present disclosure is a secondary particle having a larger particle size and a higher sphericity degree formed from several particulates having smaller particle sizes and lower sphericity degrees. Isotropy of the negative electrode active material is relatively high, and the particulates in the secondary particle make a migration path of lithium ions relatively short, so that the lithium ions can be intercalated and deintercalated quickly, implementing fast charging performance of the battery.

### CROSS-REFERENCE TO RELATED APPLICATIONS

The present disclosure is a continuation-in-part (CIP) of International Application No. PCT/CN2022/142629, filed on Dec. 28, 2022, which claims priority to Chinese Patent Application No. 202210288026.5, filed on Mar. 22, 2022. The disclosures of the aforementioned applications are hereby incorporated by reference in their entireties.

### TECHNICAL FIELD

The present disclosure pertains to the technical field of lithium-ion batteries, and specifically, relates to a negative electrode active material, and a negative electrode plate and a battery including the negative electrode active material.

### BACKGROUND

Commercialization of lithium-ion batteries has brought great convenience to people's lives. Lithium-ion batteries are more or less indispensable to apparatuses of various sizes from mobile phones to portable computers and from Bluetooth headsets to electric vehicles. However, with the development of society and the advancement of science and technology, people have imposed increasingly high requirements on fast charging performance of lithium-ion batteries.

### SUMMARY

The present disclosure provides a solution to a problem that a charging time of an existing battery is long. “Polycrystalline spherical graphite” is constructed by controlling a structure of a negative electrode active material; and a negative electrode active material having a relatively high sphericity degree is obtained by controlling shapes and sizes of “particulates” in the “polycrystalline spherical graphite”. A battery assembled from the negative electrode active material has a fast charging capability, achieving a “flash charge” effect.

The negative electrode active material of the present disclosure is a secondary particle having a larger particle size and a higher sphericity degree formed from several particulates having smaller particle sizes and lower sphericity degrees. Isotropy of the negative electrode active material is higher, and the particulates in the secondary particle make a migration path of lithium ions relatively short, so that the lithium ions may be intercalated and deintercalated quickly, implementing fast charging performance of the battery.

The present disclosure is intended to be implemented by using the following technical solutions.

A negative electrode active material is provided. The negative electrode active material is granular, and has a secondary particle structure formed by binding several particulates; a particle size distribution Dv50 of the particulates is greater than or equal to 0.5 μm and less than or equal to 5 μm, a tapped density of the particulates is greater than 0 and less than or equal to 1 g/cm³, and a granular sphericity degree of the particulates is greater than 0 and less than or equal to 1; and a particle size distribution Dv50 of the negative electrode active material is greater than or equal to 5 μm and less than or equal to 50 μm, a tapped density of the negative electrode active material is greater than or equal to 0.8 g/cm³ and less than or equal to 1.5 g/cm³, and a granular sphericity degree of the negative electrode active material is greater than or equal to 0.5 and less than or equal to 1.

Beneficial effects of the present disclosure are as follows.

Disclosed are a negative electrode active material, and a negative electrode plate and a battery including the negative electrode active material. The inventors surprisingly found that “polycrystalline spherical graphite” is constructed by controlling a structure of a negative electrode active material, and that a negative electrode active material having a relatively high sphericity degree is obtained by controlling shapes and sizes of “particulates” in the “polycrystalline spherical graphite”. A battery assembled from the negative electrode active material has a fast charging capability, achieving a “flash charge” effect. Further, isotropy of the negative electrode active material of the present disclosure is higher, and the particulates in the secondary particle make a migration path of lithium ions relatively short, so that the lithium ions can be intercalated and deintercalated quickly, implementing fast charging performance of the battery.

### BRIEF DESCRIPTION OF THE DRAWINGS

FIG. 1 is a Scanning Electron Microscope (SEM) image of a negative electrode active material in a negative electrode plate of a lithium-ion battery prepared in Example 1.

FIG. 2 is a graph of charge-discharge curves of the lithium-ion battery prepared in Example 1 at a charging rate of 10C.

FIG. 3 is a schematic structural diagram of a negative electrode active material according to a preferred solution of the present disclosure.

### DETAILED DESCRIPTION OF THE EMBODIMENTS

Specific implementations of the present disclosure are described below in detail. It should be understood that the specific implementations described herein are merely used for the purposes of illustrating and explaining the present disclosure, rather than limiting the present disclosure.

The present disclosure provides a negative electrode active material. The negative electrode active material is granular, and has a secondary particle structure formed by binding several particulates.

A particle size distribution Dv50 of the particulates is greater than or equal to 0.5 μm and less than or equal to 5 μm, a tapped density of the particulates is greater than 0 and less than or equal to 1 g/cm³, and a granular sphericity degree of the particulates is greater than 0 and less than or equal to 1.

A particle size distribution Dv50 of the negative electrode active material is greater than or equal to 5 μm and less than or equal to 50 μm, a tapped density of the negative electrode active material is greater than or equal to 0.8 g/cm³ and less than or equal to 1.5 g/cm³, and a granular sphericity degree of the negative electrode active material is greater than or equal to 0.5 and less than or equal to 1.

In an embodiment, “several” means greater than or equal to 2.

The particle size distribution Dv50 of the particulates is greater than or equal to 0.5 μm and less than or equal to 5 μm, for example, is 0.5 μm, 0.6 μm, 0.7 μm, 0.8 μm, 0.9 μm, 1 μm, 1.5 μm, 1.8 μm, 2 μm, 2.5 μm, 2.8 μm, 3 μm, 4 μm, 5 μm, or a point value in a range formed by any two of the foregoing values.

Preferably, the particle size distribution Dv50 of the particulates is greater than or equal to 0.5 μm and less than or equal to 3 μm.

In an embodiment, the tapped density of the particulates is greater than 0 and less than or equal to 1 g/cm³, for example, is 0.2 g/cm^{3, 0.3} g/cm³, 0.4 g/cm^{3, 0.5} g/cm^{3, 0.6} g/cm³, 0.8 g/cm³, 1 g/cm³, or a point value in a range formed by any two of the foregoing values.

Preferably, the tapped density of the particulates is greater than or equal to 0.2 g/cm³ and less than or equal to 0.6 g/cm³.

The tapped density of the particulates may be obtained by using a conventional method in the art, for example, with reference to GB/T 1482-2016.

In an embodiment, the granular sphericity degree of the particulates is greater than 0 and less than or equal to 1, for example, is 0.1, 0.2, 0.3, 0.4, 0.5, 0.6, 0.8, 1, or a point value in a range formed by any two of the foregoing values.

Preferably, the granular sphericity degree of the particulates is greater than or equal to 0.1 and less than or equal to 0.6.

In an embodiment, when the particle size distribution Dv50 of the particulates is greater than or equal to 0.5 μm and less than or equal to 5 μm, the tapped density of the particulates is greater than 0 and less than or equal to 1 g/cm³, and the granular sphericity degree of the particulates is greater than 0 and less than or equal to 1, the particulates may be bound into the negative electrode active material having a high sphericity degree. Particularly, when the particle size distribution Dv50 of the particulates is greater than 5 μm, the tapped density and the sphericity degree of the particulates are high. However, a contact area between the particulates is small. As a result, after a coating layer raw material used for binding the particulates into a negative electrode active material of a secondary particle structure is added into the particulates, it is hard for the particulates to be bound into the negative electrode active material having the high sphericity degree. When the particle size distribution Dv50 of the particulates is less than 0.5 μm, a particle size of the particulate is too small. In this case, a specific surface area is relatively large, there are many defects on a surface structure of a material, and a larger amount of the coating layer raw material used for binding the particulates into a negative electrode active material of a secondary particle structure needs to be consumed. As a result, a discharge capacity and initial efficiency of a finally obtained negative electrode active material are low.

In an embodiment, the negative electrode active material having a high sphericity degree is constructed from a plurality of particulates, so that isotropy of the negative electrode active material may be increased, facilitating fast intercalation and deintercalation of lithium ions in a battery. In addition, an infiltration effect of an electrolyte solution to the negative electrode active material is better, improving a charging rate of the battery. After heat treatment is performed on a coating layer raw material used for binding the particulates into a negative electrode active material of a secondary particle structure, a soft carbon or hard carbon material with relatively high electrical conductivity is formed, which may form a conductive network and accelerate transmission of electrons. This is also beneficial to C-rate improvement of lithium ions.

In an embodiment, the particle size distribution Dv50 of the negative electrode active material is greater than or equal to 5 μm and less than or equal to 50 μm, for example, is 5 μm, 10 μm, 11 μm, 12 μm, 13 μm, 14 μm, 15 μm, 16 μm, 17 μm, 18 μm, 19 μm, 20 μm, 22 μm, 24 μm, 25 μm, 26 μm, 28 μm, 30 μm, 40 μm, 50 μm, or a point value in a range formed by any two of the foregoing values.

Preferably, the particle size distribution Dv50 of the negative electrode active material is greater than or equal to 10 μm and less than or equal to 30 μm.

In an embodiment, the tapped density of the negative electrode active material is greater than or equal to 0.8 g/cm³ and less than or equal to 1.5 g/cm³, for example, is 0.8 g/cm^{3, 1.0} g/cm³, 1.05 g/cm³, 1.1 g/cm³, 1.15 g/cm³, 1.2 g/cm³, 1.3 g/cm³, 1.4 g/cm³, 1.5 g/cm³, or a point value in a range formed by any two of the foregoing values.

Preferably, the tapped density of the negative electrode active material is greater than or equal to 1 g/cm³ and less than or equal to 1.2 g/cm³.

The tapped density of the negative electrode active material may be obtained by using a conventional method in the art, for example, with reference to GB/T 1482-2016.

In an embodiment, the granular sphericity degree of the negative electrode active material is greater than or equal to 0.5 and less than or equal to 1, for example, is 0.5, 0.55, 0.6, 0.65, 0.7, 0.75, 0.8, 0.85, 0.9, 0.95, 1, or a point value in a range formed by any two of the foregoing values.

Preferably, the granular sphericity degree of the negative electrode active material is greater than or equal to 0.7 and less than or equal to 0.9.

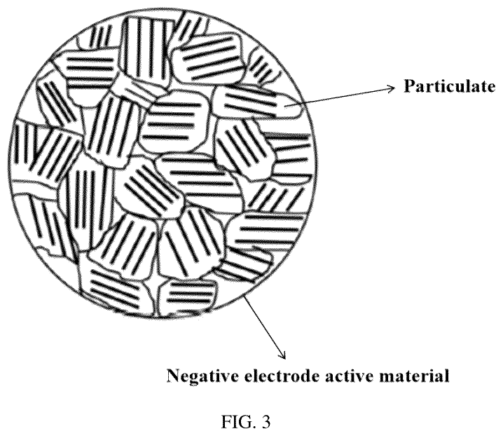

FIG. 3 is a schematic structural diagram of a negative electrode active material according to a preferred solution of the present disclosure.

In an embodiment, Dv50 is a particle size whose cumulative particle distribution is 50%, that is, a volume content of particles whose particle sizes are smaller than this particle size accounts for 50% of a total volume of all particles. Dv50 is also referred to as median diameter or median particle size, and is a typical value of particle sizes. The value accurately divides all particles into two equal parts, that is, particle sizes of 50% of the particles are greater than this value, and particle sizes of the other 50% of the particles are smaller than this value. If Dv50 of a sample is equal to 5 μm, it indicates that among all particles of the sample, particle sizes of 50% of the particles are greater than 5 μm, and particle sizes of the other 50% of the particles are smaller than 5 μm.

In an embodiment, the particle size distribution is tested according to a laser particle size method using an instrument whose model is Mastersizer 3000.

In an embodiment, the granular sphericity degree is tested using a Microtrac S3500SI laser particle size and particle shape analyzer.

In an embodiment, the negative electrode active material has a secondary particle structure formed by binding several particulates via a coating layer.

In an embodiment, surfaces of the several particulates are coated with the coating layer.

In an embodiment, in a process of mixing the particulates and a raw material of the coating layer, the raw material of the coating layer preferentially diffuses into the surfaces of the particulates, so that the surfaces of the particulates are infiltrated, forming the coating layer. After all the particulates are infiltrated completely, a residual amount of the raw material of the coating layer binds all the particulates together to form the negative electrode active material having a relatively high sphericity degree.

In an embodiment, a mass ratio of the particulates to the coating layer ranges from 100:10 to 100:30, for example, is 100:10, 100:15, 100:20, 100:25, 100:30, or a point value in a range formed by any two of the foregoing values.

In an embodiment, a component of the particulate includes a carbon material, and the carbon material is selected from one or more of natural graphite, artificial graphite, soft carbon, hard carbon, or the like.

In an embodiment, a material forming the coating layer is selected from one or more of hard carbon, soft carbon, graphene, conductive carbon black, or the like.

In an embodiment, the coating layer is prepared from one or more of the following raw materials of the coating layer:

asphalt (liquid petroleum asphalt), epoxy resin, petroleum heavy oil, phenolic resin, graphene dispersion, carbon nanotube dispersion, polyvinyl alcohol, polyvinylpyrrolidone, or sodium carboxymethyl cellulose.

Preferably, the coating layer is prepared from a raw material of the coating layer via spray drying, heat treatment, and carbonization; or the coating layer is prepared from a raw material of the coating layer via spray drying, heat treatment, and graphitization.

Preferably, the coating layer is prepared, via spray drying, heat treatment, and carbonization, from the foregoing material forming the coating layer; or the coating layer is prepared, via spray drying, heat treatment, and graphitization, from the foregoing material forming the coating layer.

For example, a component of the particulate includes a carbon material. When the carbon material is selected from one or more of artificial graphite, soft carbon, hard carbon, or the like, the coating layer is prepared from the raw material of the coating layer via spray drying, heat treatment, and carbonization.

For example, a component of the particulate includes a carbon material. When the carbon material is selected from natural graphite, the coating layer is prepared from the raw material of the coating layer via spray drying, heat treatment, and graphitization.

In an embodiment, the spray drying is carried out in a spray drying device; a temperature of the spray drying ranges from 80° C. to 200° C. (for example, is 80° C., 90° C., 100° C., 150° C., 200° C., or a point value in a range formed by any two of the foregoing values); and a time of the spray drying ranges from 5 hours to 10 hours (for example, is 5 hour, 6 hours, 7 hours, 8 hours, 9 hours, 10 hours, or a point value in a range formed by any two of the foregoing values).

In an embodiment, the heat treatment is carried out in a reactor; a temperature of the heat treatment ranges from 450° C. to 650° C. (for example, is 450° C., 500° C., 550° C., 600° C., 650° C., or a point value in a range formed by any two of the foregoing values); and a time of the heat treatment ranges from 5 hours to 15 hours (for example, is 5 hours, 10 hours, 15 hours, or a point value in a range formed by any two of the foregoing values).

In an embodiment, the carbonization is carried out in a reactor; a temperature of the carbonization ranges from 800° C. to 1500° C. (for example, is 800° C., 900° C., 1000° C., 1100° C., 1200° C., 1300° C., 1400° C., 1500° C., or a point value in a range formed by any two of the foregoing values); and a time of the carbonization ranges from 12 hours to 24 hours (for example, is 12 hours, 18 hours, 24 hours, or a point value in a range formed by any two of the foregoing values).

In an embodiment, the graphitization is carried out in a reactor; a temperature of the graphitization is above 2800° C.; and a time of the graphitization ranges from 1 hour to 24 hours (for example, is 1 hour, 5 hours, 10 hours, 15 hours, 20 hours, 24 hours, or a point value in a range formed by any two of the foregoing values).

In an embodiment, the material forming the coating layer may be prepared before being mixed with the particulates, or may be prepared in situ after the raw material of the coating layer is mixed with the particulates.

In an embodiment, a spray drying process may uniformly mix the material forming the coating layer or the raw material of the coating layer with the particulates, and bind the particulates together, so that the raw material of the coating layer or the material forming the coating layer is distributed more uniformly, and coating is more complete; a heat treatment process may discharge a redundant volatile component from the raw material of the coating layer, so that spherical secondary particles do not bind to each other during carbonization; a carbonization process may carbonize the uniformly mixed materials, to obtain one or more of hard carbon, soft carbon, graphene, conductive carbon black, or the like; and a graphitization process may graphitize the uniformly mixed materials, to obtain soft carbon having a graphite structure, thereby improving a capacity and press density of natural graphite.

When the particulates are natural graphite, and the coating layer is prepared in situ, a relatively large amount of the raw material of the coating layer needs to be added to ensure that natural graphite can bind into spherical secondary particles. As a result, after the volatile component is discharged via heat treatment, a content of amorphous carbon is relatively high. After graphitization, the amorphous carbon may be converted into a graphite structure, so that a capacity and press density of natural graphite are improved, avoiding an impact on initial discharge efficiency and a press density of the negative electrode active material. In addition, natural graphite has a high ash content and is not purified, and purification may be further performed on natural graphite after graphitization.

In an embodiment, a ratio of a strength D₀₀₄ of a crystal surface 004 of the negative electrode active material to a strength D₁₁₀ of a crystal surface 110 of the negative electrode active material (the ratio is defined as an OI value of the negative electrode active material) ranges from 1 to 5 (for example, is 1, 2, 3, 4, 5, or a point value in a range formed by any two of the foregoing values), indicating isotropy of the negative electrode active material.

The strength D₀₀₄ of the crystal surface 004 of the negative electrode active material and the strength D₁₁₀ of the crystal surface 110 of the negative electrode active material may be obtained by using a conventional method in the art, for example, using an X-ray powder diffractometer.

An embodiment further provides a method for preparing the foregoing negative electrode active material. The method includes the following steps:

(1) preparing particulates, where a particle size distribution Dv50 of the particulates is greater than or equal to 0.5 μm and less than or equal to 5 μm, a tapped density of the particulates is greater than 0 and less than or equal to 1 g/cm³, and a granular sphericity degree of the particulates is greater than 0 and less than or equal to 1; and

(2) mixing the particulates in step (1) with a raw material of a coating layer, and preparing the negative electrode active material via spray drying, heat treatment, carbonization, shaping, classification, sieving, and demagnetization, where a particle size distribution Dv50 of the negative electrode active material is greater than or equal to 5 μm and less than or equal to 50 μm, a tapped density of the negative electrode active material is greater than or equal to 0.8 g/cm³ and less than or equal to 1.5 g/cm³, and a granular sphericity degree of the negative electrode active material is greater than or equal to 0.5 and less than or equal to 1; or

mixing the particulates in step (1) with a raw material of a coating layer, and preparing the negative electrode active material via spray drying, heat treatment, graphitization, shaping, classification, sieving, and demagnetization, where a particle size distribution Dv50 of the negative electrode active material is greater than or equal to 5 μm and less than or equal to 50 μm, a tapped density of the negative electrode active material is greater than or equal to 0.8 g/cm³ and less than or equal to 1.5 g/cm³, and a granular sphericity degree of the negative electrode active material is greater than or equal to 0.5 and less than or equal to 1; or

mixing the particulates in step (1) with a material forming a coating layer, and preparing the negative electrode active material via shaping, classification, sieving, and demagnetization, where a particle size distribution Dv50 of the negative electrode active material is greater than or equal to 5 μm and less than or equal to 50 μm, a tapped density of the negative electrode active material is greater than or equal to 0.8 g/cm³ and less than or equal to 1.5 g/cm³, and a granular sphericity degree of the negative electrode active material is greater than or equal to 0.5 and less than or equal to 1.

In an embodiment, the particulate is defined as above.

In an embodiment, the raw material of the coating layer is defined as above.

In an embodiment, a mass ratio of the particulates to the raw material of the coating layer ranges from 100:10 to 100:30, for example, is 100:10, 100:15, 100:20, 100:25, 100:30, or a point value in a range formed by any two of the foregoing values.

In an embodiment, a mass ratio of the particulates to the coating layer ranges from 100:10 to 100:30, for example, is 100:10, 100:15, 100:20, 100:25, 100:30, or a point value in a range formed by any two of the foregoing values.

In an embodiment, the spray drying is carried out in a spray drying device; a temperature of the spray drying ranges from 80° C. to 200° C. (for example, is, 80° C., 90° C., 100° C., 110° C., 120° C., 130° C., 140° C., 150° C., 160° C., 170° C., 180° C., 190° C., 200° C., or a point value in a range formed by any two of the foregoing values); and a time of the spray drying ranges from 5 hours to 10 hours (for example, is, 5 hours, 6 hours, 7 hours, 8 hours, 9 hours, 10 hours, or a point value in a range formed by any two of the foregoing values).

In an embodiment, the heat treatment is carried out in a reactor; a temperature of the heat treatment ranges from 450° C. to 650° C. (for example, is, 450° C., 500° C., 550° C., 600° C., 650° C., or a point value in a range formed by any two of the foregoing values); and a time of the heat treatment ranges from 5 hours to 15 hours (for example, is, 5 hours, 6 hours, 7 hours, 8 hours, 9 hours, 10 hours, 11 hours, 12 hours, 13 hours, 14 hours, 15 hours, or a point value in a range formed by any two of the foregoing values).

In an embodiment, the carbonization is carried out in a reactor; a temperature of the carbonization ranges from 800° C. to 1500° C. (for example, is, 800° C., 900° C., 1000° C., 1100° C., 1200° C., 1300° C., 1400° C., 1500° C., or a point value in a range formed by any two of the foregoing values); and a time of the carbonization ranges from 12 hours to 24 hours (for example, is, 12 hours, 13 hours, 14 hours, 15 hours, 16 hours, 17 hours, 18 hours, 19 hours, 20 hours, 21 hours, 22 hours, 23 hours, 24 hours, or a point value in a range formed by any two of the foregoing values).

In an embodiment, the graphitization is carried out in a reactor; a temperature of the graphitization is above 2800° C.; and a time of the graphitization ranges from 1 hour to 24 hours (for example, is, 1 hours, 5 hours, 10 hours, 15 hours, 20 hours, 24 hours, or a point value in a range formed by any two of the foregoing values).

The present disclosure further provides a negative electrode plate. The negative electrode plate includes the foregoing negative electrode active material.

In an embodiment, the negative electrode plate includes a current collector and an active material layer on at least one side surface of the current collector, and the active material layer includes the negative electrode active material.

In an embodiment, the current collector is selected from at least one of copper foil, chromium foil, nickel foil, or titanium foil.

According to an implementation of the present disclosure, a press density of the negative electrode plate ranges from 1.5 g/cm³ to 1.8 g/cm³, for example, is 1.5 g/cm³, 1.6 g/cm³, 1.7 g/cm³, 1.8 g/cm³, or a point value in a range formed by any two of the foregoing values.

Preferably, the press density is obtained after roll-pressing at a pressure of 17 MPa.

In an embodiment, the active material layer may further include a conductive agent and a binder.

In an embodiment, the binder is selected from at least one of polyacrylic acid, sodium polyacrylate, potassium polyacrylate, lithium polyacrylate, polyvinyl alcohol, carboxymethyl cellulose (CMC), sodium carboxymethyl cellulose, polyimide, polyamideimide, styrene-butadiene rubber (SBR), or polyvinylidene fluoride (PVDF). For example, the binder is a mixture of carboxymethyl cellulose and styrene-butadiene rubber.

In an embodiment, the conductive agent is selected from at least one acetylene black, conductive carbon black, single-walled carbon nanotube, multi-walled carbon nanotube, or graphene.

The present disclosure further provides a battery. The battery includes the foregoing negative electrode active material and/or the foregoing negative electrode plate.

In an embodiment, the battery has a relatively high energy density, for example, an energy density ranges from 500 Wh/L to 600 Wh/L.

The present disclosure is further described in detail below with reference to specific embodiments. It should be understood that the following embodiments are merely for the purposes of illustrating and explaining the present disclosure, and should not be construed as limiting the scope of protection of the present disclosure. Any technology implemented based on the foregoing contents of the present disclosure falls within the intended scope of protection of the present disclosure.

Experimental methods used in the following Examples are all conventional methods, unless otherwise specified. Reagents, materials, and the like used in the following Examples are all commercially available, unless otherwise specified.

Related tests of the following Examples and Comparative Examples are as follows:

A particle size was tested according to a laser method using Mastersize 3000 (Malvern 3000). A granular sphericity degree was tested using a Microtrac S3500SI laser particle size and particle shape analyzer.

### EXAMPLE 1

A negative electrode active material was prepared as follows: Crushing and shaping were performed on petroleum needle coke to obtain an artificial graphite raw material. The artificial graphite raw material was added into a graphite crucible for graphitization, where a temperature of the graphitization was above 3000° C., and an artificial graphite material was obtained after temperature reduction. Shaping and classification were performed on the obtained artificial graphite material, to obtain artificial graphite particulates (related parameters are shown in Table 1). The artificial graphite particulates and petroleum heavy oil were mixed at a mass ratio of 100:13. Spray drying was performed at 150° C. for 5 hours. Heat treatment was performed at 550° C. for 10 hours. Then, carbonization was performed at 1100° C. for 24 hours. Subsequently, sieving and demagnetization were performed to obtain an artificial graphite negative electrode active material having a specific sphericity degree (related parameters are shown in Table 1).

A process of assembling a button battery prepared above is as follows: Under a condition of 25° C., the prepared negative electrode active material was uniformly mixed with CMC, conductive carbon black, and SBR at a mass ratio of 92%: 1.5%: 1.5%: 5% in pure water, to prepare a slurry; the slurry was uniformly coated on a copper foil with a thickness of 8 μm, where a surface density for coating was 8 mg/cm²; then, the copper foil was placed in a vacuum drying oven, and dried at 80° C. for 12 hours; and a dried electrode plate was cut into round pieces with a diameter of 20 mm, to obtain the negative electrode plate.

Under a condition of 25° C., a lithium metal sheet was used as a counter electrode; the negative electrode plate obtained above was used as a working electrode; a polyethylene separator was used as a battery separator; 1 mol/L of LiPF₆ and a mixed solution of ethylene carbonate (EC) and diethyl carbonate (DEC) that were at a volume ratio of 1:1 were used as an electrolyte solution; and a CR2430-type button battery was assembled in a glove box that was in an argon environment. A press density of the negative electrode plate was 1.5 g/cm³; and a single surface density of the negative electrode plate was 8 mg/cm².

After the assembled button battery was left standing at room temperature for 24 hours, an electrochemical test was performed using an American Arbin BT2000-type battery tester.

Testing of a capacity and an initial efficiency: 0.05 C discharging was performed till 5 m V was reached; standing was performed for 10 minutes; a 0.05 mA discharging was performed till 5 mV was reached, to obtain an initial lithium intercalation capacity of the negative electrode active material; standing was performed for 10 minutes; and then, 0.1 C charging was performed till 2.0 V was reached, to complete a first cycle and obtain an initial lithium deintercalation capacity of the negative electrode active material. The initial lithium deintercalation capacity was divided by a mass of the negative electrode active material, to obtain an initial discharge specific capacity of the negative electrode active material. A quotient of the initial lithium deintercalation capacity divided by the initial lithium intercalation capacity was the initial efficiency of the negative electrode active material.

A process of assembling a pouch battery is as follows: A negative electrode slurry was prepared from a negative electrode active material, conductive carbon black, CMC, and SBR that were at a mass ratio of 95%: 2%: 1.2%: 1.8%. The negative electrode slurry was uniformly coated on copper foil with a thickness of 8 μm. A single surface density of a negative electrode plate was 5 mg/cm³; and a press density of the negative electrode plate was 1.5 g/cm³. A positive electrode active material was NCM523. A positive electrode slurry was prepared by uniformly mixing NCM523, conductive carbon black, and PVDF at a mass ratio of 96.5%: 2%: 1.5%. An electrolyte solution was a solution composed of 1 mol/L LiPF6, and EC, dimethyl carbonate (DMC), and ethyl methyl carbonate (EMC) that were at a volume ratio of 1.5:1.5:7. A separator used was a polyethylene separator. A positive electrode design capacity was 170 mAh/g. A negative electrode design capacity was designed based on a capacity test result of a half battery. A CB value was 1.15. After the pouch battery was assembled, the pouch full battery charge and discharge test was performed using an Arbin BT2000-type battery tester, where a charge and discharge range was set to 4.3 V to 2.75 V. FIG. 1 is an SEM image of a negative electrode active material in a negative electrode plate of a lithium-ion battery prepared in Example 1.

A method for testing a constant-current charge rate at a charging rate of 10 C is as follows.

1. In an environment of 25° C., a battery was discharged at a current density of 0.5 C to a lower limit voltage 2.75 V of the battery.

2. The battery was left standing for 15 minutes.

3. The battery was charged at a current density of 10 C to an upper limit voltage 4.3 V, and then was charged at a constant voltage of 4.3 V, where a cut-off current was 0.05 C.

4. The battery was left standing for 15 minutes.

5. The battery was discharged at a current density of 0.5 C to 2.75 V.

Constant-current charge rate =Charge capacity in a constant-current phase/Total charge capacity of a battery*100%.

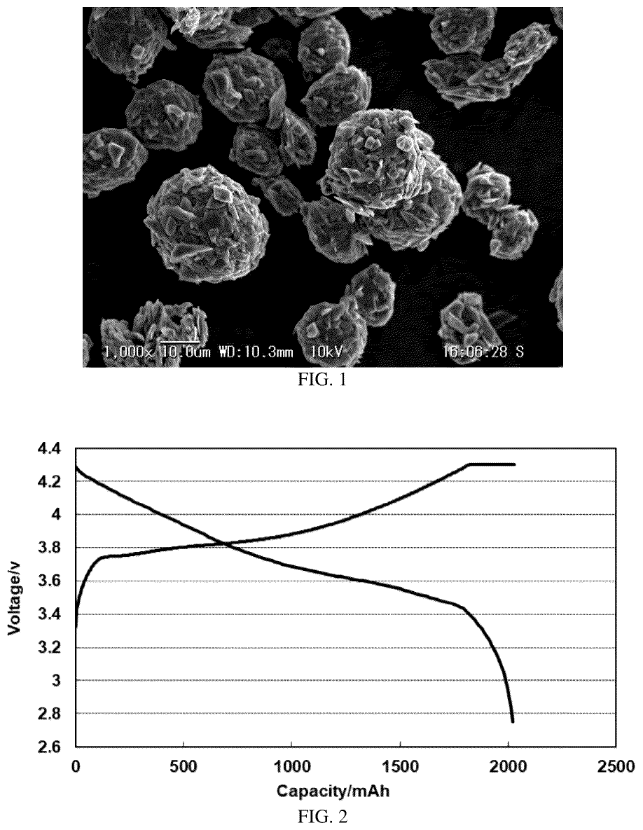

FIG. 2 is a graph of charge-discharge curves of the lithium-ion battery prepared in Example 1 at a charging rate of 10 C.

A charge and discharge cycling capacity retention rate of a pouch battery was tested as follows.

1. In an environment of 25° C., the battery was discharged at a current density of 0.5 C to a lower limit voltage 2.75 V of the battery.

2. The battery was left standing for 30 minutes.

3. The battery was charged at a current density of 10 C to an upper limit voltage 4.3 V, and then was charged at a constant voltage of 4.3 V, where a cut-off current was 0.05 C.

4. The battery was left standing for 30 minutes.

5. The battery was discharged at a current density of 1 C to a lower limit voltage 2.75 V.

6. Steps 2 to 5 were one charge and discharge cycle, and were performed repeatedly for 1000 cycles.

Capacity retention rate of the pouch battery after 1000 cycles=Discharge capacity of the 1000th cycle/Discharge capacity of the first cycle*100%.

### EXAMPLE 2

A negative electrode active material was prepared as follows: Crushing and shaping were performed on coal-based needle coke to obtain an artificial graphite raw material. The artificial graphite raw material was added into a graphite crucible for graphitization, where a temperature of the graphitization was above 3000° C., and an artificial graphite material was obtained after temperature reduction. Shaping and classification were performed on the obtained artificial graphite material, to obtain artificial graphite particulates (related parameters are shown in Table 1). The artificial graphite particulates and epoxy resin were mixed at a mass ratio of 100:15. Spray drying was performed at 180° C. for 8 hours. Heat treatment was performed at 550° C. for 10 hours. Then, carbonization was performed at 1100° C. for 24 hours. Subsequently, sieving and demagnetization were performed to obtain an artificial graphite negative electrode active material having a specific sphericity degree (related parameters are shown in Table 1).

Processes of preparing and testing a button battery and a pouch battery are consistent with those in Example 1.

### EXAMPLE 3

A negative electrode active material was prepared as follows: Crushing and shaping were performed on natural flake graphite to obtain a natural graphite raw material. Crushing and classification were performed on the obtained natural graphite raw material, to obtain natural graphite particulates (related parameters are shown in Table 1). The natural graphite particulates and liquid petroleum asphalt were mixed at a mass ratio of 100:18. Spray drying was performed at 180° C. for 5 hours. Heat treatment was performed at 550° C. for 10 hours, to obtain a natural graphite material. The natural graphite material was added into a graphite crucible for graphitization, where a temperature of the graphitization was above 3000° C. Sieving and demagnetization were performed after temperature reduction of the material, to obtain a natural graphite negative electrode active material having a specific sphericity degree (related parameters are shown in Table 1).

Processes of preparing and testing a button battery and a pouch battery are consistent with those in Example 1.

### EXAMPLE 4

A negative electrode active material was prepared as follows: Crushing and shaping were performed on common petroleum coke to obtain an artificial graphite raw material. The artificial graphite raw material was added into a graphite crucible for graphitization, where a temperature of the graphitization was above 3000° C., and an artificial graphite material was obtained after temperature reduction. Shaping and classification were performed on the obtained artificial graphite material, to obtain graphite particulates (related parameters are shown in Table 1). The graphite particulates, epoxy resin, and a graphene slurry were mixed at a mass ratio of 100:10:5. Spray drying was performed at 150° C. for 5 hours. Heat treatment was performed at 500° C. for 10 hours. Then, carbonization was performed at 1200° C. for 12 hours. Subsequently, sieving and demagnetization were performed to obtain an artificial graphite negative electrode active material having a specific sphericity degree (related parameters are shown in Table 1).

Processes of preparing and testing a button battery and a pouch battery are consistent with those in Example 1.

### EXAMPLE 5

A negative electrode active material was prepared as follows: Crushing and shaping were performed on asphalt coke to obtain an artificial graphite raw material. The artificial graphite raw material was added into a graphite crucible for carbonization, where a temperature of the carbonization ranged from 800° C. to 1300° C., and a soft carbon negative electrode material was obtained after temperature reduction. Shaping and classification were performed on the obtained soft carbon material, to obtain soft carbon particulates (related parameters are shown in Table 1). The soft carbon particulates and phenolic resin were mixed at a mass ratio of 100:15. Spray drying was performed at 150° C. for 10 hours. Heat treatment was performed at 500° C. for 10 hours. Then, carbonization was performed at 1200° C. for 12 hours. Subsequently, sieving and demagnetization were performed to obtain a soft carbon negative electrode active material having a specific sphericity degree (related parameters are shown in Table 1).

Processes of preparing and testing a button battery and a pouch battery are consistent with those in Example 1.

### EXAMPLE 6 TO EXAMPLE 13

These Examples were performed with reference to Example 1, where related parameters of artificial graphite particulates are shown in Table 1, and related parameters of a negative electrode active material are shown in Table 1.

Processes of preparing and testing a button battery and a pouch battery are consistent with those in Example 1.

### EXAMPLE 14 AND EXAMPLE 15

These Examples were performed with reference to Example 1, and a difference lied in that a mass ratio of artificial graphite particulates to petroleum heavy oil was changed. Details are as follows:

In Example 14, the mass ratio of artificial graphite particulates to petroleum heavy oil was 100:10, where related parameters of artificial graphite particulates and a negative electrode active material are shown in Table 1.

In Example 15, the mass ratio of artificial graphite particulates to petroleum heavy oil was 100:30, where related parameters of artificial graphite particulates and a negative electrode active material are shown in Table 1.

Processes of preparing and testing a button battery and a pouch battery are consistent with those in Example 1.

A ratio of a strength D₀₀₄ of a crystal surface 004 of the negative electrode active material prepared in Examples 1 to 15 to a strength D₁₁₀ of a crystal surface 110 of the negative electrode active material ranged from 1 to 5.

### Comparative Example 1

A negative electrode active material was prepared as follows: Crushing and shaping were performed on petroleum needle coke to obtain an artificial graphite raw material. The artificial graphite raw material was added into a graphite crucible for graphitization, where a temperature of the graphitization was above 3000° C., and an artificial graphite material was obtained after temperature reduction. Shaping and classification were performed on the obtained artificial graphite material, to obtain artificial graphite particulates (related parameters are shown in Table 1). The artificial graphite particulates and petroleum heavy oil were mixed at a mass ratio of 100:8. Then, carbonization was performed at 1100° C. for 24 hours. Subsequently, sieving and demagnetization were performed to obtain an artificial graphite negative electrode active material having a specific sphericity degree (related parameters are shown in Table 1).

Processes of preparing and testing a button battery and a pouch battery are consistent with those in Example 1.

### Comparative Example 2

A negative electrode active material was prepared as follows: Crushing and shaping were performed on natural flake graphite to obtain a natural graphite raw material. Crushing and classification were performed on the obtained natural graphite raw material, to obtain natural graphite particulates (related parameters are shown in Table 1). The natural graphite particulates and petroleum asphalt were mixed at a mass ratio of 100:30. Heat treatment was performed at 600° C. for 10 hours, to obtain a natural graphite material. The material was added into a graphite crucible for graphitization, where a temperature of the graphitization was above 3000° C. Sieving and demagnetization were performed after temperature reduction of the material, to obtain a natural graphite negative electrode active material (related parameters are shown in Table 1).

Processes of preparing and testing a button battery and a pouch battery are consistent with those in Example 1.

### Comparative Example 3

A negative electrode active material was prepared as follows: Crushing and shaping were performed on petroleum needle coke to obtain an artificial graphite raw material. The artificial graphite raw material was added into a graphite crucible for graphitization, where a temperature of the graphitization was above 3000° C., and an artificial graphite material was obtained after temperature reduction. Shaping and classification were performed on the obtained artificial graphite material, to obtain artificial graphite particulates (related parameters are shown in Table 1). The artificial graphite particulates and petroleum heavy oil were mixed at a mass ratio of 100:15. Heat treatment was performed at 600° C. for 8 hours. Then, carbonization was performed at 1100° C. for 24 hours. Subsequently, sieving and demagnetization were performed to obtain an artificial graphite negative electrode active material (related parameters are shown in Table 1).

Processes of preparing and testing a button battery and a pouch battery are consistent with those in Example 1.

Test results of negative electrode active materials in the foregoing Examples and Comparative Examples and performance test results of button batteries and lithium-ion batteries (the lithium-ion batteries are the pouch batteries mentioned above) assembled from the negative electrode active materials in the foregoing Examples and Comparative Examples are shown in Table 1.

TABLE 1
Performance test results of negative electrode active materials and batteries assembled
from the negative electrode active materials in Examples and Comparative Examples

| | | | | | | | | | Performance of a | |
|---|---|---|---|---|---|---|---|---|---|---|
| | Physical property | | | | | | | | lithium-ion battery | |
| | parameter of a negative | | | Performance of | | Physical property | | | | Capacity |
| | electrode active material | | | a button battery | | parameter of particulates | | | Constant- | retention |
| | Particle | | | Initial | | Particle | | | current | rate after |
| | size | | | discharge | | size | | | charge rate | 1000 cycles |
| Negative | distribution | Tapped | | specific | Initial | distribution | Tapped | | at a rate | at 10 C/1 |
| electrode | D50 | density | Sphericity | capacity | efficiency | D50 | density | Sphericity | of 10 C | and 25° C. |
| material | (μm) | (g/cm³) | degree | (mAh/g) | (%) | (μm) | (g/cm³) | degree | (%) | (%) |
| Example 1 | 13.4 | 0.98 | 0.85 | 351 | 93.2 | 1.2 | 0.40 | 0.35 | 90 | 96.5 |
| Example 2 | 15.6 | 1.03 | 0.88 | 353 | 92.6 | 2.6 | 0.36 | 0.27 | 88 | 95 |
| Example 3 | 10.5 | 0.92 | 0.84 | 365 | 91.8 | 0.8 | 0.25 | 0.15 | 92 | 93 |
| Example 4 | 16.2 | 1.00 | 0.90 | 348 | 93.5 | 2.2 | 0.41 | 0.33 | 92 | 98 |
| Example 5 | 18.4 | 0.82 | 0.78 | 285 | 84.0 | 2.5 | 0.30 | 0.35 | 95 | 97 |
| Example 6 | 17.5 | 0.95 | 0.82 | 355 | 92.4 | 3.8 | 0.32 | 0.40 | 84 | 87 |
| Example 7 | 19.3 | 0.99 | 0.84 | 357 | 93.1 | 5.0 | 0.27 | 0.45 | 81 | 83 |
| Example 8 | 10.4 | 0.86 | 0.70 | 323 | 87.5 | 0.6 | 0.12 | 0.38 | 93 | 93 |
| Example 9 | 12.7 | 0.94 | 0.87 | 348 | 90.4 | 1.8 | 0.60 | 0.85 | 94 | 95 |
| Example 10 | 15.0 | 0.98 | 0.9 | 353 | 92.2 | 2.3 | 0.8 | 0.85 | 96 | 96 |
| Example 11 | 10.0 | 0.65 | 0.58 | 255 | 85.0 | 0.7 | 0.20 | 0.05 | 85 | 89 |
| Example 12 | 13.0 | 1.05 | 0.80 | 352 | 92.8 | 1.6 | 0.53 | 0.60 | 92 | 94 |
| Example 13 | 14.8 | 1.10 | 0.97 | 355 | 93.5 | 1.8 | 0.70 | 0.98 | 95 | 97 |
| Example 14 | 12.6 | 0.95 | 0.83 | 355 | 93.5 | 1.2 | 0.40 | 0.35 | 86 | 93 |
| Example 15 | 14.5 | 1.03 | 0.91 | 345 | 92.0 | 1.2 | 0.40 | 0.35 | 93 | 97 |
| Comparative | 12.5 | 0.86 | 0.50 | 347 | 93.8 | 11.8 | 0.81 | 0.48 | 67 | 72 |
| Example 1 | | | | | | | | | | |
| Comparative | 17.5 | 1.06 | 0.75 | 363 | 94.3 | 9.0 | 0.72 | 0.65 | 55 | 60 |
| Example 2 | | | | | | | | | | |
| Comparative | 16.7 | 1.05 | 0.38 | 357 | 94.2 | 7.8 | 0.65 | 0.30 | 60 | 65 |
| Example 3 | | | | | | | | | | |

It can be seen from the results in the foregoing table that the negative electrode active materials in Examples 1 to 5 are negative electrode active materials having relatively large particle sizes (10 μm to 20 μm) and relatively high sphericity degrees (0.7 to 0.9) that were obtained by binding small particles having relatively small particle sizes (0.5 μm to 3 μm) and relatively small sphericity degrees (0.1 to 0.4). These materials have relatively high isotropy in negative electrode plates, and the small particles provide shorter migration paths of lithium ions. Therefore, such a material has relatively high fast charging performance.

For those skilled in the art, it is apparent that the present disclosure is not limited to the details of the foregoing exemplary embodiments, and can be implemented in other specific forms without departing from the spirit or basic features of the present disclosure. Therefore, the embodiments should be regarded as exemplary and non-limiting in every respect, and the scope of the present disclosure is defined by the appended claims rather than the above description. Therefore, all changes falling within the meaning and scope of equivalent elements of the claims should be included in the present disclosure.

The implementations of the present disclosure are described above. However, the present disclosure is not limited to the foregoing implementations. Any modifications, equivalent replacements, improvements, and the like within the spirit and principle of the present disclosure shall fall within the scope of protection of the present disclosure.

What is claimed is:

1. A negative electrode active material, wherein the negative electrode active material is granular, and has a secondary particle structure formed by binding several particulates;
a particle size distribution Dv50 of the particulates is greater than or equal to 0.5 μm and less than or equal to 5 μm, a tapped density of the particulates is greater than 0 and less than or equal to 1 g/cm³, and a granular sphericity degree of the particulates is greater than 0 and less than or equal to 1; and
a particle size distribution Dv50 of the negative electrode active material is greater than or equal to 5 μm and less than or equal to 50 μm, a tapped density of the negative electrode active material is greater than or equal to 0.8 g/cm³ and less than or equal to 1.5 g/cm³, and a granular sphericity degree of the negative electrode active material is greater than or equal to 0.5 and less than or equal to 1.

2. The negative electrode active material according to claim 1, wherein the particle size distribution Dv50 of the particulates is greater than or equal to 0.5 μm and less than or equal to 3 μm; and/or
the tapped density of the particulates is greater than or equal to 0.2 g/cm³ and less than or equal to 0.6 g/cm³; and/or
the granular sphericity degree of the particulates is greater than or equal to 0.1 and less than or equal to 0.6.

3. The negative electrode active material according to claim 1, wherein the particle size distribution Dv50 of the negative electrode active material is greater than or equal to 10 μm and less than or equal to 30 μm; and/or
the tapped density of the negative electrode active material is greater than or equal to 1 g/cm³ and less than or equal to 1.2 g/cm³; and/or
the granular sphericity degree of the negative electrode active material is greater than or equal to 0.7 and less than or equal to 0.9.

4. The negative electrode active material according to claim 1, wherein the negative electrode active material has a secondary particle structure formed by binding several particulates via a coating layer.

5. The negative electrode active material according to claim 4, wherein surfaces of the several particulates are coated with the coating layer.

6. The negative electrode active material according to claim 4, wherein a mass ratio of the particulates to the coating layer ranges from 100:10 to 100:30.

7. The negative electrode active material according to claim 5, wherein a mass ratio of the particulates to the coating layer ranges from 100:10 to 100:30.

8. The negative electrode active material according to claim 1, wherein a component of the particulate comprises a carbon material.

9. The negative electrode active material according to claim 8, wherein the carbon material is selected from one or more of natural graphite, artificial graphite, soft carbon, or hard carbon.

10. The negative electrode active material according to claim 4, wherein a material forming the coating layer is selected from one or more of hard carbon, soft carbon, graphene, or conductive carbon black.

11. The negative electrode active material according to claim 4, wherein the coating layer is prepared from one or more of a following raw material of the coating layer: asphalt, epoxy resin, petroleum heavy oil, phenolic resin, graphene dispersion, carbon nanotube dispersion, polyvinyl alcohol, polyvinylpyrrolidone, or sodium carboxymethyl cellulose.

12. The negative electrode active material according to claim 4, wherein the coating layer is prepared from a raw material of the coating layer via spray drying, heat treatment, and carbonization; or
the coating layer is prepared from a raw material of the coating layer via spray drying, heat treatment, and graphitization.

13. The negative electrode active material according to claim 12, wherein a mass ratio of the particulates to the raw material of the coating layer ranges from 100:10 to 100:30.

14. The negative electrode active material according to claim 1, wherein a ratio of a strength D₀₀₄ of a crystal surface 004 of the negative electrode active material to a strength D₁₁₀ of a crystal surface 110 of the negative electrode active material ranges from 1 to 5.

15. A negative electrode plate, wherein the negative electrode plate comprises the negative electrode active material according to claim 1.

16. The negative electrode plate according to claim 15, wherein the negative electrode plate comprises a current collector and an active material layer on at least one side surface of the current collector, and the active material layer comprises the negative electrode active material.

17. The negative electrode plate according to claim 15, wherein a press density of the negative electrode plate ranges from 1.5 g/cm³ to 1.8 g/cm³.

18. A battery, wherein the battery comprises the negative electrode active material according to claim 1.

19. The battery according to claim 18, wherein an energy density of the battery ranges from 500 Wh/L to 600 Wh/L.

20. A battery, wherein the battery comprises the negative electrode plate according to claim 15.
